(19) United States
(12) Patent Application Publication
(10) Pub. No.: US 2022/0022358 A1
(43) Pub. Date: Jan. 27, 2022

(54) CIRCULAR GROUND ENGAGING BLADE WITH WEAR RESISTANT COATING

(71) Applicant: Osmundson Mfg. Co., Perry, IA (US)

(72) Inventor: Douglas G. Bruce, West Des Moines, IA (US)

(21) Appl. No.: 16/934,610

(22) Filed: Jul. 21, 2020

(51) Int. Cl. A01B 15/16

(52) U.S. Cl. CPC A01B 15/16

(57) ABSTRACT

An agricultural ground engaging blade with a wear resistant coating having a generally circular plate with a first side and a second side and an outer periphery disposed around an outer diameter of the plate. One or more bands of wear resistant coating are applied at or near the outer periphery in a pattern that is configured to reduce wear caused by a particular soil type. Bands of wear resistant coating are applied in an X pattern to the outer periphery to prevent wear in sandy soil. Generally circular concentric bands of wear resistant coating varying in distance apart from each other are applied to the outer periphery to prevent wear in rocky soil. Generally sinusoidal concentric bands of wear resistant coating are applied to the outer periphery to prevent wear in black or sticky soil.

### FIELD OF THE DISCLOSURE

This disclosure relates generally to an improved ground engaging blade for an agricultural implement such as a tillage device or planter, and in particular to a disc blade or notch blade with a wear resistant coating. In one arrangement, the disclosure relates to a ground engaging blade with wear resistant coating applied in patterns that are specific to soil type.

### BACKGROUND OF THE DISCLOSURE

Various tillage devices are used to turn and work soil for agricultural purposes. One type of tillage device is a disc blade, sometimes called a coulter blade or a planter blade. Such blades often have a generally circular sharpened outer periphery. Another type of tillage device is a notch blade, which has a generally circular sharpened outer periphery with a series of notches disposed around the outer periphery. A number of such blades are typically rotatably mounted on an agricultural implement via a shaft, and each blade rotates about the shaft due to contact with the soil as the implement moves over the soil. Disc blades may be mounted to an agricultural tillage device to turn and prepare the soil for planting, or disc blades may be mounted to the row units of an agricultural planter in order to open furrows in which seeds are planted.

Various designs for agricultural ground engaging blades exist, examples of which include U.S. Pat. Nos. 5,855,246, 6,554,079, 7,497,270, 7,878,262, and 10,390,471. Due to the abrasive nature of the soil that blades and other ground engaging agricultural devices encounter, such devices become worn and periodically require replacement. Replacement of ground engaging agricultural devices leads to expense and down time while the worn part is replaced. Further, soil types vary from location to location, and different soil types produce different wear patterns on ground engaging blades. Wear resistant coatings have been applied to the edges of ground engaging agricultural blades to improve blade longevity; however, a single wide swath of wear resistant coating is typically applied around the periphery of the blade with no differentiation in application patterns based on soil type. Such over-application of wear resistant coating leads to wasted material without improving blade longevity.

For the reasons stated above, and for other reasons which will become apparent to those skilled in the art upon reading and understanding the specification, there is a need in the art for an improved ground engaging blade with wear resistant coating.

Thus it is a primary object of the disclosure to provide a ground engaging blade with wear resistant coating that prevents wear using minimal wear resistant coating.

These and other objects, features, or advantages of the present disclosure will become apparent from the specification and claims.

### BRIEF SUMMARY OF THE DISCLOSURE

The disclosure relates to an improved ground engaging blade with wear resistant coating. The disclosure relates to application of wear resistant coating along the periphery of a ground engaging blade in a pattern that is specific to soil type.

### BRIEF DESCRIPTION OF THE DRAWINGS

FIG. 1 depicts a ground engaging blade.

FIG. 2 depicts a ground engaging blade with wear resistant coating pattern for sandy soil according to one embodiment.

FIG. 3 depicts a ground engaging blade with wear resistant coating pattern for rocky soil according to one embodiment.

FIG. 4 depicts a ground engaging blade with wear resistant coating pattern for black or sticky soil according to one embodiment.

FIG. 5 depicts a notched ground engaging blade with wear resistant coating according to one embodiment.

### DETAILED DESCRIPTION

In the following detailed description of the embodiments, reference is made to the accompanying drawings which form a part hereof, and in which is shown by way of illustration specific preferred embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the present disclosures. The following detailed description is, therefore, not to be taken in a limiting sense, and the scope of the present disclosure is defined only by the appended claims, along with the full scope of equivalents to which such claims are entitled.

As used herein, the terminology such as vertical, horizontal, top, bottom, front, back, end and sides are referenced according to the views presented. It should be understood, however, that the terms are used only for purposes of description, and are not intended to be used as limitations. Accordingly, orientation of an object or a combination of objects may change without departing from the scope of the disclosure.

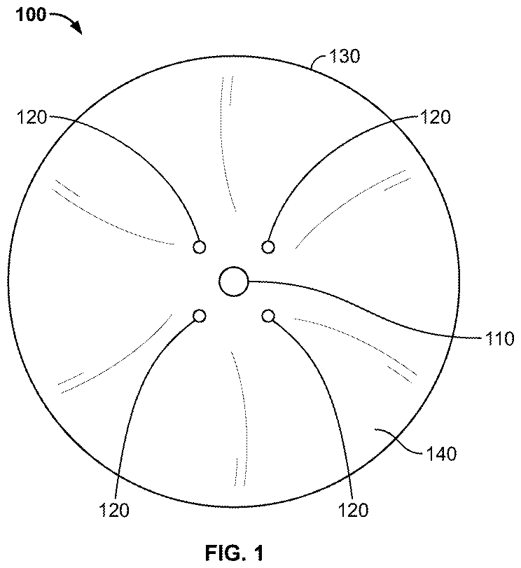

Throughout the disclosure, ground engaging blade 100 may be referred to as simply “blade 100.” As shown in FIG. 1, an example of a ground engaging blade 100 comprises a plate 140. Blade 100 may comprise a center hole 110 disposed at or near the center of plate 140 for rotatably mounting the ground engaging blade 100 to a shaft on an agricultural implement; however some ground engaging blades 100 do not include a center hole 110. Center hole 110 may be formed of any shape, size, or position at or near the center of plate 140, or may be omitted without departing from the scope of the disclosure. Plate 140 may comprise a flat plate, a convex/concave surface, or another shape suitable for tillage or furrow opening purposes. Further, plate 140 comprises a first side, a second side, and an outer periphery 130 about its diameter. The outer periphery 130 may be generally circular, a generally circular shape with a notched edge, a generally circular shape with a sine wave edge, or any other shape suitable for tillage or furrow opening purposes. The outer periphery 130 may be sharpened. The outer periphery 130 may comprise a beveled edge, in which case application of wear resistant coating 150 begins where the bevel edge ends. Optional bolt holes 120 for optionally bolting a bearing structure onto the ground engaging blade 100 may be disposed near at or near the center of blade 100. Bolt holes 120 may be formed of any shape, size, configuration, spacing, or position on blade 100, or may be omitted without departing from the scope of the disclosure.

Ground engaging blade 100 may be constructed from steel or any other metal or material suitable for use as a ground-engaging device. The ground engaging blade 100 can be as wide or narrow as desired. A number of blades 100 can be cut from a single sheet of material in order to conserve the material, reduce waste and give the farmer as much material as possible in order to enhance the performance and longevity of the blade 100 to be made therefrom. After cutting a number of blades 100 from a single sheet of material, the flat pieces cut from the material may be shaped and cut to form the various parts of blade 100 described in this disclosure.

In operation, the movement of the agricultural implement to which the blade 100 is mounted causes the blade 100 to rotate, thus cutting the soil. Over time, the blade 100 gradually wears from its original shape to a worn condition as a result of encountering soil, rocks, roots, and other objects.

To extend the useful life of blade 100, a wear resistant coating 150 may be applied near the outer periphery 130 of the blade 100. Wear resistant coating 150 may comprise carbide particles, tungsten carbide coating or any other material suitable for preventing wear of a ground engaging blade 100. The wear resistant coating 150 may be applied to the blade 100 using any application method. For example, wear resistant coating 150 may be welded, sprayed, rolled, brushed, dabbed, etched, deposited, applied by laser, deposited by plasma or detonation gun, or brushed onto the blade 100. Alternatively, the blade 100 may be dipped in wear resistant coating 150.

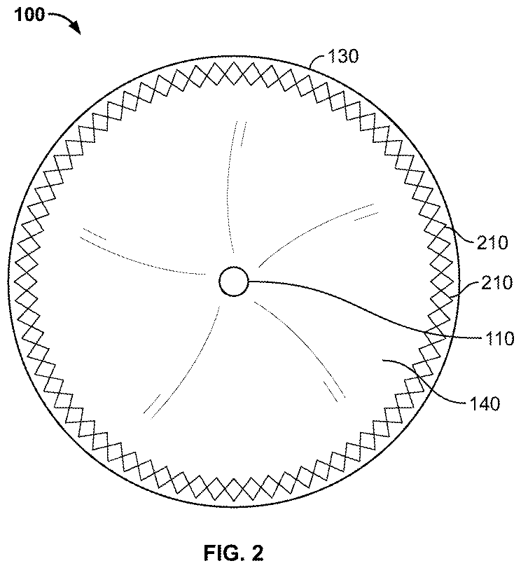

Agricultural soil types vary from location to location, and soil type affects the wear pattern ground engaging blade 100 experiences. Wear resistant coating 150 may be applied in differing patterns based on soil type as shown in FIGS. 2-5. One or more bands of wear resistant coating 150 may be applied near the outer periphery 130 of the ground engaging blade 100 wherein the shape of the bands of wear resistant coating 150 are determined by the soil type that will be encountered by the blade 100. The shapes of the bands of wear resistant coating 150 direct the wear pattern that will be experienced by the blade 100. Bands of wear resistant coating 150 may be applied at any distance from the outer periphery 130 of blade 100; however, it is ideal that bands of wear resistant coating 150 be applied such that the closest point of wear resistant coating 150 is 0.75 inches or less from the outer periphery 130. Wear resistant coating 150 may be applied in any thickness without departing from the scope of the disclosure.

As shown in FIG. 2, one or more bands of wear resistant coating 150 may be applied to a first side, a second side, or both sides of ground engaging blade 100 in a pattern specific to sandy soil. To protect ground engaging blade 100 in sandy soil, an X pattern 210 of wear resistant coating 150 is applied around the outer periphery 130. The X pattern 210 of wear resistant coating 150 comprises a series of X's applied in a band around the outer periphery 130. In one embodiment, the individual X's of the X pattern 210 of wear resistant coating touch each other; however, the individual X's of the X pattern 210 may alternatively be spaced apart from one another. In one embodiment, blade 100 comprises a concave/convex plate 140, and first and second bands 210 of wear resistant coating 150 are applied to the first or convex side of plate 140. Alternatively or additionally, wear resistant coating 150 may be applied to the second or concave side of plate 140. When wear resistant coating 150 is applied to both sides of blade 100, wear resistant coating 150 may be applied in the same pattern on both sides or different patterns of wear resistant coating 150 may be applied on each side of blade 100. The term “sandy” soil refers to a generally abrasive soil type, and there are many different types of sandy soils including soft sandy soil, sandy soil with pea rock, sandy soil with large rocks, and other abrasive soils. Due to the wide variety of sandy soil types, it is difficult to predict which pattern of wear resistant coating 150 will be most effective at preventing wear on a blade 100. Customers may submit worn blades 100 to the manufacturer for analysis of wear patterns, and subsequent blades 100 produced for that individual customer will have customized wear resistant coating 150 patterns that are most effective for the customer's specific soil type.

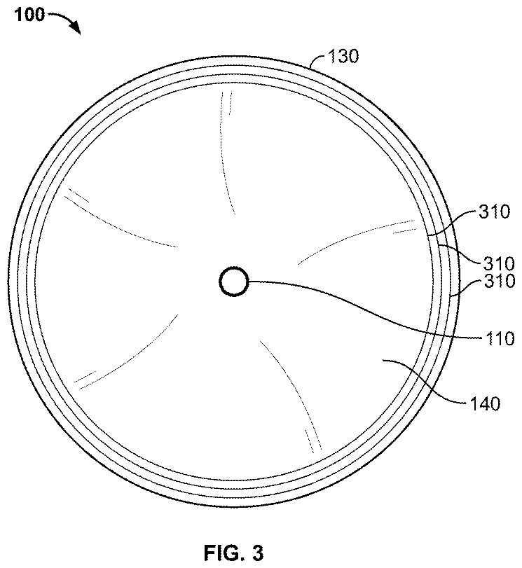

As shown in FIG. 3, one or more bands of wear resistant coating 150 may be applied to a first side, a second side, or both sides of ground engaging blade 100 in a pattern specific to rocky soil.

To protect ground engaging blade 100 in rocky soil, first, second, and third concentric generally circular bands 310 of wear resistant coating 150 varying in distance apart from each other are applied around the outer periphery 130. The generally circular bands 310 may be spaced at equal intervals from each other, or may be spaced at different distances from each other without departing from the scope of the disclosure. In one embodiment, blade 100 comprises a concave/convex plate 140, and first, second, and third concentric bands 310 of wear resistant coating 150 are applied to the first or convex side of plate 140. Alternatively or additionally, wear resistant coating 150 may be applied to the second or concave side of plate 140. When wear resistant coating 150 is applied to both sides of blade 100, wear resistant coating 150 may be applied in the same pattern on both sides or different patterns of wear resistant coating 150 may be applied on each side of blade 100.

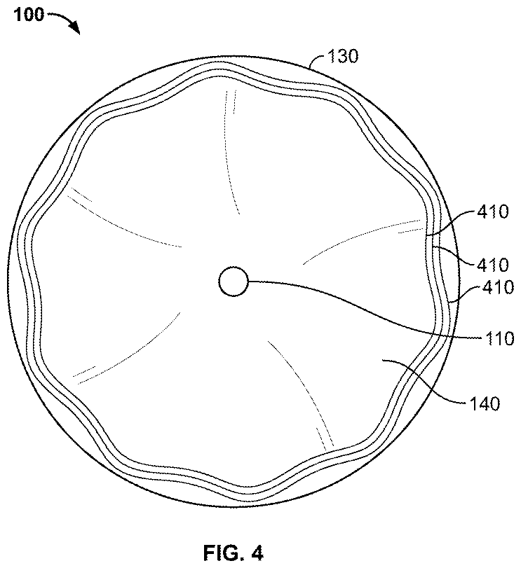

As shown in FIG. 4, one or more bands of wear resistant coating 150 may be applied to a first side, a second side, or both sides of ground engaging blade 100 in a pattern specific to black or sticky soil. To protect ground engaging blade 100 in black or sticky soil, first, second, and third generally sinusoidal bands 410 of wear resistant coating 150 are applied around the outer periphery 130. In one embodiment, the first, second, and third generally sinusoidal bands 410 do not overlap or intersect, and the peaks and troughs of first, second, and third sinusoidal bands 410 are aligned with each other. Over time, the outer periphery 130 of a ground engaging blade 100 with bands 410 of wear resistant coating applied in this manner will wear down to a scalloped edge, which performs favorably for cutting debris that is typically found in agricultural fields and can interfere with planting operations. In one embodiment, blade 100 comprises a concave/convex plate 140, and first, second, and third concentric bands 410 of wear resistant coating 150 are applied to the first or convex side of plate 140. Alternatively or additionally, wear resistant coating 150 may be applied to the second or concave side of plate 140. When wear resistant coating 150 is applied to both sides of blade 100, wear resistant coating 150 may be applied in the same pattern on both sides or different patterns of wear resistant coating 150 may be applied on each side of blade 100.

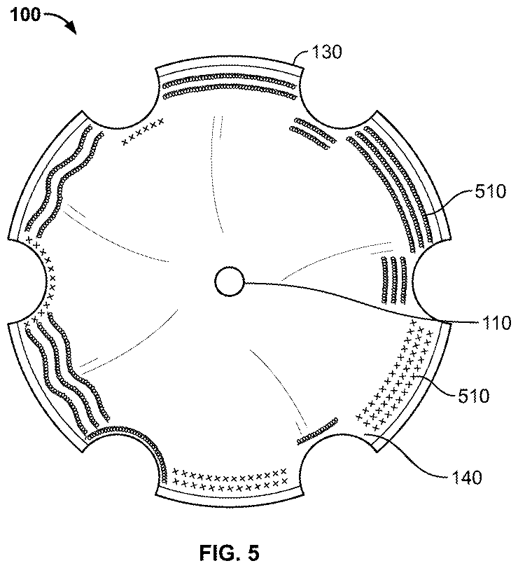

As shown in FIG. 5, wear resistant coating 150 may be applied to a first side, a second side, or both sides of a notched ground engaging blade 100 having a series of notches 510 disposed around the outer periphery 130. To protect a notched ground engaging blade 100, wear resistant coating 150 is applied around each notch 510 and between notches 510 in a pattern specific to soil type. For rocky soil, wear resistant coating 150 is applied near each notch 510 in one or more rows or bands 520 adjacent each notch 510. The bands or rows 520 may be generally parallel to the line formed by the two points at which notch 510 intersects the outer periphery 130 and also generally parallel to each other, in which case the rows 520 are applied at or near the point on notch 510 that is closest to the center of blade 100. Alternatively, the rows 520 may match the shape of the notch 510. Any number or spacing of bands or rows 520 may be used without departing from the scope of the disclosure. For rocky soil, wear resistant coating 150 is also applied at or near the outer periphery 130 between adjacent notches 510 in a pattern of one or more bands or rows 525. Bands or rows 525 may be generally parallel to the line formed by the nearest two points at which each adjacent notch 510 intersects the outer periphery 130 and also generally parallel to each other. Alternatively, bands or rows 525 may match the shape of the outer periphery 130. Any number or spacing of bands or rows 525 may be used without departing from the scope of the disclosure. For sandy soil, wear resistant coating 150 is applied near each notch 510 in one or more bands or rows of X's 530 adjacent to each notch 510. The bands of X's 530 may be generally parallel to the line formed by the two points at which notch 510 intersects the outer periphery 130 and generally parallel to each other, in which case the bands of X's 530 are applied at or near to the point on each notch 510 that is closest to the center of blade 100. Alternatively, the bands of X's 530 may match the shape of the notch 510. Any number or spacing of the bands of X's 530 may be used without departing from the scope of the disclosure. For sandy soil, wear resistant coating 150 is also applied at or near the outer periphery 130 between adjacent notches 510 in one or more rows or bands of X's 535. Bands of X's 535 may be generally parallel to the line formed by the nearest two points at which each adjacent notch 510 intersects the outer periphery 130 and also generally parallel to each other. Alternatively, bands of X's 535 may match the shape of the outer periphery 130. Any number or spacing of bands of X's 535 may be used without departing from the scope of the disclosure.

For black or sticky soil, wear resistant coating 150 is applied near each notch 510 in one or more sinusoidal bands or rows 540 adjacent to each notch 510. A line passing through each peak of each sinusoidal band 540 may be generally parallel to the line formed by the two points at which notch 510 intersects the outer periphery 130 and also generally parallel to each other, in which case the sinusoidal bands 540 are applied at or near to the point on each notch 510 that is closest to the center of blade 100. Alternatively, the sinusoidal bands 540 may match the shape of the notch 510. Any number or spacing of sinusoidal bands 540 may be used without departing from the scope of the disclosure. For black or sticky soil, wear resistant coating 150 is also applied at or near the outer periphery 130 between adjacent notches 510 in one or more sinusoidal rows or bands 545. A line passing through each peak of each sinusoidal band 545 may be generally parallel to the line formed by the nearest two points at which each adjacent notch 510 intersects the outer periphery 130 and also generally parallel to each other. Alternatively, the sinusoidal bands 545 may match the shape of the outer periphery 130. Any number or spacing of sinusoidal bands 545 may be used without departing from the scope of the disclosure. When wear resistant coating 150 is applied to both sides of blade 100, wear resistant coating 150 may be applied in the same pattern on both sides or different patterns of wear resistant coating 150 may be applied on each side of blade 100.

Each soil-specific pattern of wear resistant coating 150 is considered ideal for most instances of the soil type described; however soil types are highly variable. In particular, there are many types of sandy or abrasive soils, each of which may produce a unique wear pattern. It is anticipated that some equipment owners may experience different wear patterns based on their specific soil, and the shapes, dimensions, and locations of wear resistant coating 150 may be customized to counter specific wear patterns. It is anticipated that some equipment owners may experience different wear patterns based on their specific soil, and the shapes, dimensions, and locations of wear resistant coating 150 may be customized to counter specific wear patterns. Further, shapes, dimensions, locations, and thicknesses of wear resistant coating 150 may be customized to achieve an acceptable balance of wear resistant properties and manufacturing cost for a particular customer. Customers may submit worn blades 100 to the manufacturer for analysis of wear patterns, and subsequent blades 100 produced for that individual customer will have customized wear resistant coating 150 patterns that are most effective for the customer's specific soil type.

The ground engaging blade 100 with wear resistant coating 150 has many benefits and advantages including, but not limited to reducing the expense and lost working time associated with replacing worn ground engaging components. These and other benefits and advantages of the ground engaging blade 100 are apparent from the specification and claims.

### REFERENCE NUMERALS

100—ground engaging blade, also called blade
110—center hole
120—bolt holes
130—outer periphery
140—plate
150—wear resistant coating
210—X pattern of wear resistant coating 150
310—circular bands of wear resistant coating 150
410—sinusoidal bands of wear resistant coating 150
510—notches
520—rows or bands of wear resistant coating 150 applied at or near notches 510
525—rows or bands of wear resistant coating 150 applied between notches 510
530—rows or bands of X pattern of wear resistant coating 150 applied at or near notches 510
535—rows or bands of X pattern of wear resistant coating 150 applied between notches 510
540—sinusoidal rows or bands of wear resistant coating 150 applied at or near notches 510
545—sinusoidal rows or bands of wear resistant coating 150 applied between notches 510

What is claimed:

1. A wear resistant ground engaging blade comprising:
a generally circular plate having a first side and a second side;
an outer periphery disposed around an outer diameter of the plate; and
one or more bands of wear resistant coating applied at or near the outer periphery,
wherein the one or more bands of wear resistant coating have a shape that is configured to reduce wear caused by a particular soil type.

2. The wear resistant ground engaging blade of claim 1 wherein the soil type comprises sandy soil and the one or more bands of wear resistant coating comprises a series of X's applied in a band at or near the outer periphery.

3. The wear resistant ground engaging blade of claim 1 wherein the soil type comprises rocky soil and the one or more bands of wear resistant coating comprises a first generally circular band, a second generally circular band, and a third generally circular band.

4. The wear resistant ground engaging blade of claim 3 wherein the first, second, and third generally circular bands are concentric.

5. The wear resistant ground engaging blade of claim 4 wherein the first, second, and third generally circular bands vary in distance apart from each other.

6. The wear resistant ground engaging blade of claim 1 wherein the soil type comprises black or sticky soil and the one or more bands of wear resistant coating comprises a first generally sinusoidal band, a second generally sinusoidal band, and a third generally sinusoidal band.

7. The wear resistant ground engaging blade of claim 6 wherein the first, second, and third generally sinusoidal bands are concentric.

8. The wear resistant ground engaging blade of claim 1 wherein the first side of the plate comprises a convex shaped side, the second side of the plate comprises a concave shaped side, and the bands of wear resistant coating are applied to the convex shaped side.

9. The wear resistant ground engaging blade of claim 1 wherein the first side of the plate comprises a convex shaped side, the second side of the plate comprises a concave shaped side, and the bands of wear resistant coating are applied to the concave shaped side.

10. A wear resistant ground engaging blade comprising:
a generally circular plate having a first side and a second side;
an outer periphery disposed around an outer diameter of the plate;
a plurality of notches distributed around the outer periphery; and
one or more bands of wear resistant coating applied at or near each notch and between notches near the outer periphery, wherein the one or more bands of wear resistant coating have a shape that is configured to reduce wear caused by a particular soil type.

11. The wear resistant ground engaging blade of claim 10 wherein the soil type comprises sandy soil and the one or more bands of wear resistant coating comprises a series of X's applied in one or more bands at or near the outer periphery between notches and at or near each notch.

12. The wear resistant ground engaging blade of claim 10 wherein the soil type comprises sandy soil and the one or more bands of wear resistant coating comprises a series of Xs applied in generally straight lines at or near each notch and one or more generally circular bands of X's applied at or near the outer periphery between notches.

13. The wear resistant ground engaging blade of claim 10 wherein the soil type comprises rocky soil and the one or more bands of wear resistant coating comprises one or more bands applied in generally straight lines near the outer periphery between notches and at or near each notch.

14. The wear resistant ground engaging blade of claim 10 wherein the soil type comprises rocky soil and the one or more bands of wear resistant coating comprises one or more bands applied in generally straight lines at or near each notch and one or more generally circular bands applied at or near the outer periphery between notches.

15. The wear resistant ground engaging blade of claim 10 wherein the soil type comprises black or sticky soil and the one or more bands of wear resistant coating comprises one or more sinusoidal bands applied in straight lines at or near the outer periphery between notches and at or near each notch.

16. The wear resistant ground engaging blade of claim 10 wherein the soil type comprises black or sticky soil and the one or more bands of wear resistant coating comprises one or more sinusoidal bands applied in generally straight lines at or near each notch and one or more generally sinusoidal bands applied at or near the outer periphery between notches in a shape matching the outer periphery.

17. The wear resistant ground engaging blade of claim 10 wherein the first side of the plate comprises a convex shaped side, the second side of the plate comprises a concave shaped side, and the bands of wear resistant coating are applied to the convex shaped side.

18. The wear resistant ground engaging blade of claim 10 wherein the first side of the plate comprises a convex shaped side, the second side of the plate comprises a concave shaped side, and the bands of wear resistant coating are applied to the concave shaped side.
